(19) United States
(12) Patent Application Publication
(10) Pub. No.: US 2025/0219684 A1
(43) Pub. Date: Jul. 3, 2025

(54) FRONTHAUL STREAM ADAPTATION AND INTERFERENCE MITIGATION FOR MASSIVE MIMO UPLINK

(71) Applicants: Bishwarup Mondal, San Ramon, CA (US); Avik Sengupta, San Jose, CA (US); Thushara Hewavithana, Tempe, AZ (US); Ranjit Cavatur, Laguna Niguel, CA (US); Neelam Chandwani, Portland, OR (US)

(72) Inventors: Bishwarup Mondal, San Ramon, CA (US); Avik Sengupta, San Jose, CA (US); Thushara Hewavithana, Tempe, AZ (US); Ranjit Cavatur, Laguna Niguel, CA (US); Neelam Chandwani, Portland, OR (US)

(21) Appl. No.: 18/397,139

(22) Filed: Dec. 27, 2023

(51) Int. Cl. H04B 7/0452; H04W 72/12

(52) U.S. Cl. CPC H04B 7/0452; H04W 72/12

(57) ABSTRACT

A device can include communication circuitry to communicate with radio units (RUs) over a fronthaul (FH) interface. The device can include a processor coupled to the communication circuitry to receive, over the communication interface, an indication of a number of multiple-input multiple-output (MIMO) layers to be scheduled, and information identifying the one or more RUs. The processor can assign a number of streams to the one or more RUs based on the number of MIMO layers. The processor can provide the assigning to the number of RUs over the FH interface.

### TECHNICAL FIELD

Aspects pertain to wireless communications. Some aspects relate to compression and interference mitigation.

### BACKGROUND

Some communications systems in use today utilize massive multiple-input multiple-output technology. Beamforming can be applied to reduce signal dimensions as much as possible without affecting wireless performance. A balance should be reached based on capacity constraints and with the understanding that reduction of signal dimensions can impact interference mitigation.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network in which some aspects of the disclosure may be implemented.

FIG. 1B illustrates a non-roaming 5G system architecture in accordance with some aspects.

FIG. 2 illustrates an example of an Open RAN (O-RAN) system architecture in which some aspects of the disclosure may be implemented.

FIG. 3 illustrates a logical architecture of the O-RAN system of FIG. 2, in accordance with some aspects.

FIG. 4 illustrates a method for fronthaul stream adaptation in accordance with some aspects.

FIG. 5A illustrates scheduling for multiple cells in accordance with some aspects.

FIG. 5B illustrates scheduling for a single cell in accordance with some aspects.

FIG. 6 illustrates sending a non-port reduced resource element to a distributed unit in accordance with some aspects.

FIG. 7 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

### Systems and Networks

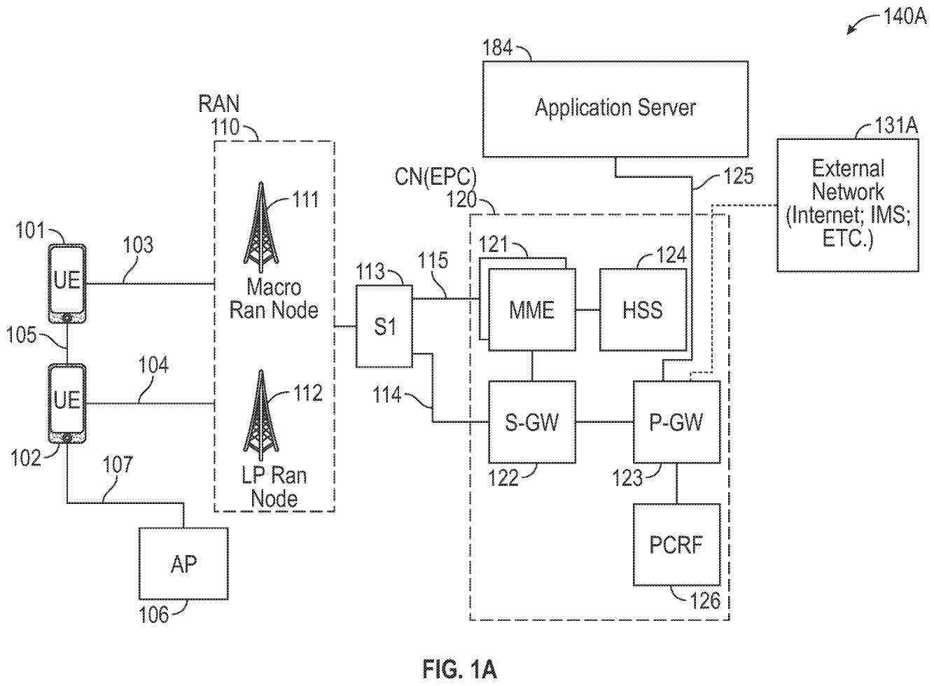

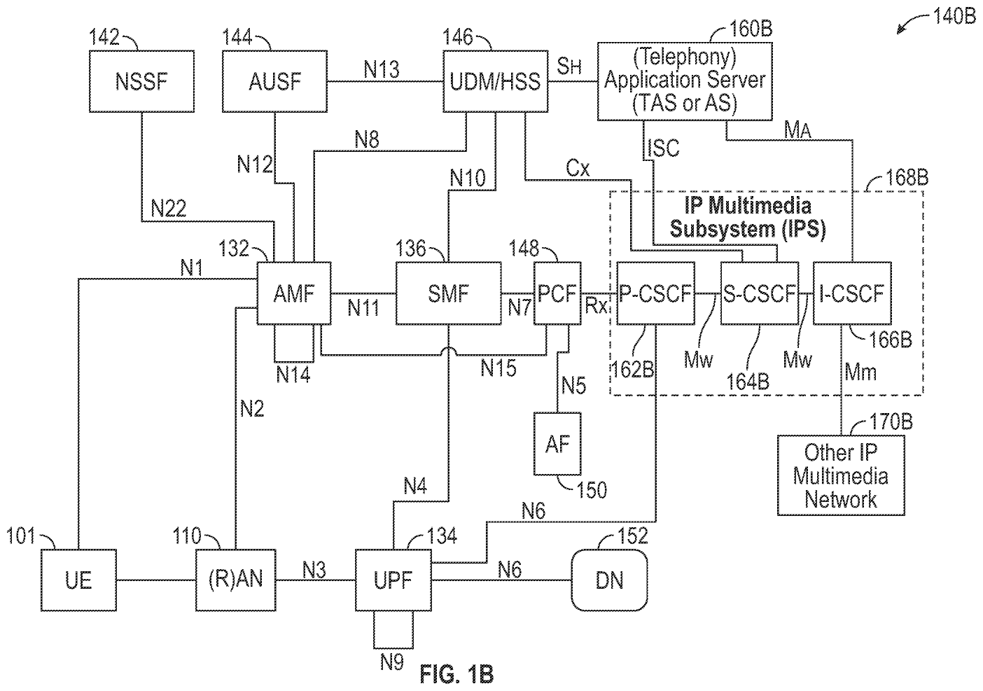

FIG. 1A illustrates an architecture of a network in which some aspects of the disclosure may be implemented. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein. Any of the radio links described herein (e.g., as used in the network 140A or any other illustrated network) may operate according to any exemplary radio communication technology and/or standard. FIG. 1B illustrates a non-roaming 5G system architecture in accordance with some aspects and is described in more detail later herein.

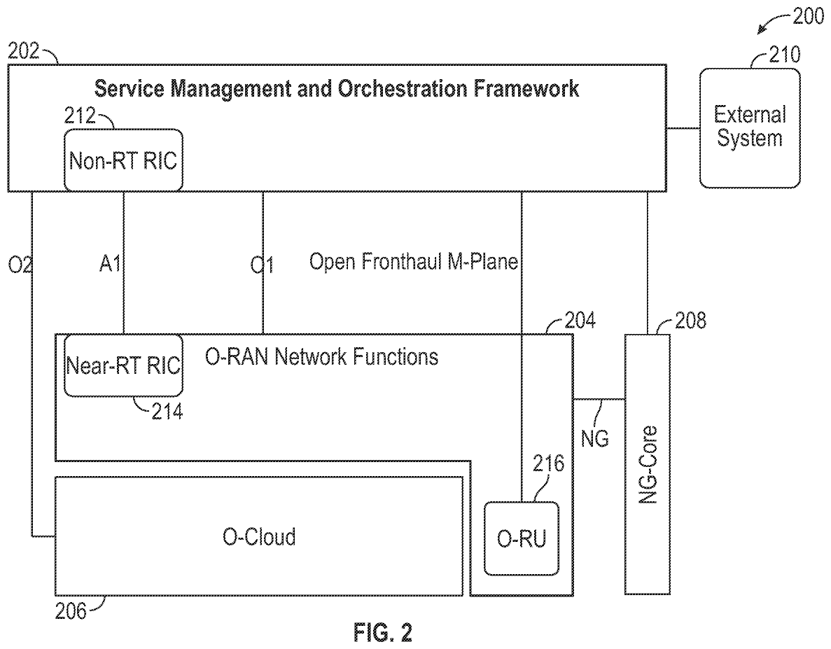

Referring now to FIG. 2, FIG. 2 provides a high-level view of an Open RAN (O-RAN) architecture 200, which can also be referred to as virtualized RAN (V-RAN). The O-RAN architecture 200 includes four O-RAN defined interfaces-namely, the A1 interface, the O1 interface, the O2 interface, and the Open Fronthaul Management (M)-plane interface-which connect the Service Management and Orchestration (SMO) framework 202 to O-RAN network functions (NFs) 204 and the O-Cloud 206. The SMO 202 also connects with an external system 210, which provides additional configuration data to the SMO 202. FIG. 2 also illustrates that the A1 interface connects the O-RAN Non-Real Time (RT) RAN Intelligent Controller (RIC) 212 in or at the SMO 202 and the O-RAN Near-RT RIC 214 in or at the O-RAN NFs 204. The O-RAN NFs 204 can be virtualized network functions (VNFs) such as virtual machines (VMs) or containers, sitting above the O-Cloud 206 and/or Physical Network Functions (PNFs) utilizing customized hardware. All O-RAN NFs 204 are expected to support the O1 interface when interfacing with the SMO framework 202. The O-RAN NFs 204 connect to the NG-Core 208 via the NG interface (which is a 3GPP-defined interface). The Open Fronthaul M-plane interface between the O-RAN Distributed Unit (DU) and the O-RAN Radio Unit (O-RU or simply RU) 216 supports the O-RU 216 management in the O-RAN hybrid model. The O-RU's termination of the Open Fronthaul M-plane interface is an optional interface to the SMO 202 that is included for backward compatibility purposes and is intended for management of the O-RU 216 in hybrid mode only. The O-RU 216 termination of the O1 interface towards the SMO 202 is specified in ORAN standards.

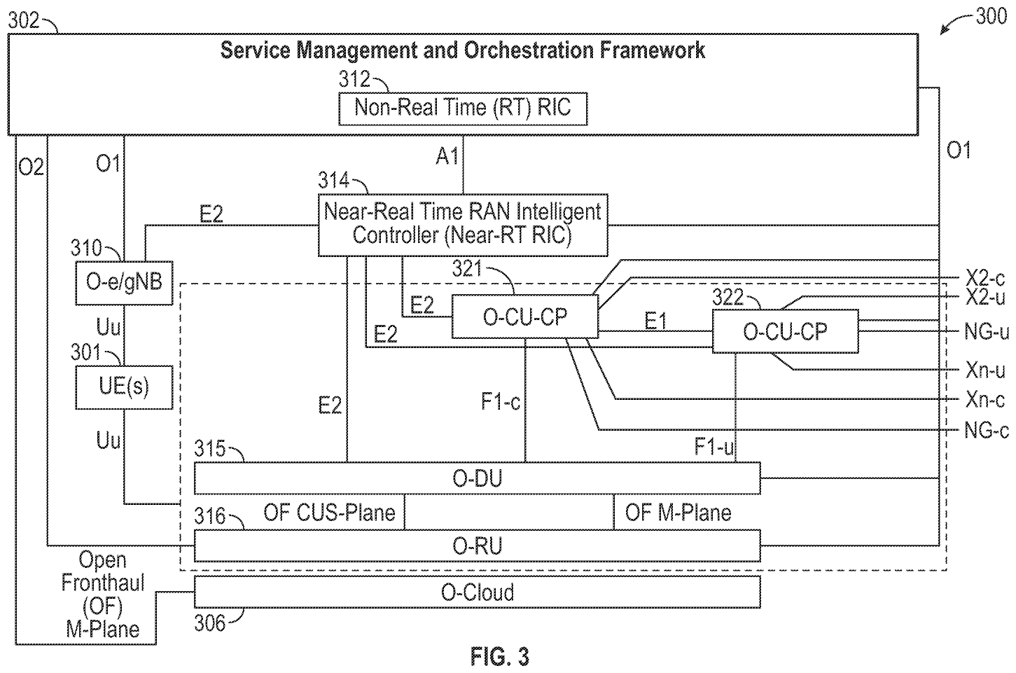

FIG. 3 shows an O-RAN logical architecture 300 corresponding to the O-RAN architecture 200 of FIG. 2. In FIG. 3, the SMO 302 corresponds to the SMO 202, O-Cloud 306 corresponds to the O-Cloud 206, the non-RT RIC 312 corresponds to the non-RT RIC 212, the near-RT RIC 314 corresponds to the near-RT RIC 214, and the O-RU 316 corresponds to the O-RU 216 of FIG. 2, respectively. The O-RAN logical architecture 300 includes a radio portion and a management portion.

The management portion/side of the architecture 300 includes the SMO Framework 302 containing the non-RT RIC 312 and may include the O-Cloud 306. The O-Cloud 306 is a cloud computing platform including a collection of physical infrastructure nodes to host the relevant O-RAN functions (e.g., the near-RT RIC 314, O-RAN Central Unit-Control Plane (O-CU-CP) 321, O-RAN Central Unit-User Plane (O-CU-UP) 322, and the O-RAN Distributed Unit (O-DU) 315), supporting software components (e.g., OSs, VMs, container runtime engines, ML engines, etc.), and appropriate management and orchestration functions.

The radio portion/side of the logical architecture 300 includes the near-RT RIC 314, the O-RAN Distributed Unit (O-DU) 315, the O-RU 316, the O-RAN Central Unit-Control Plane (O-CU-CP) 321, and the O-RAN Central Unit-User Plane (O-CU-UP) 322 functions. The radio portion/side of the logical architecture 300 may also include the O-e/gNB 310.

The O-DU 315 is a logical node hosting RLC, MAC, and higher PHY layer entities/elements (High-PHY layers) based on a lower-layer functional split. For example, a 7.2× split (or 7-2× split in some literature) between low PHY and high PHY may be implemented wherein L2, L3 and most of Llprocessing is centralized at an O-DU. The O-RU 316 is a logical node hosting lower PHY layer entities/elements (Low-PHY layer) (e.g., FFT/iFFT, PRACH extraction, etc.) and RF processing elements based on a lower layer functional split. The O-CU-CP 321 is a logical node hosting the RRC and the control plane (CP) part of the PDCP protocol. The O O-CU-UP 322 is a logical node hosting the user-plane part of the PDCP protocol and the SDAP protocol.

### Fronthaul Stream Adaptation and Interference Mitigation

Aspects of the present disclosure can be implemented in any of the system architectures and networks described with respect to FIG. 1A-FIG. 3. When a 7.2× split such as described above is used with a massive multiple-input multiple-output (MIMO) uplink, beamforming is often applied at the RU to reduce a potentially large number of streams from the received (RX) antenna ports domain to a more reasonable number of streams at output of the beamformer. The beamformer should reduce the number of output streams (hereby refers to as port reduction) as much as possible, reduce the fronthaul (FH) throughput from RU to DU, while losing as little wireless performance as possible. However, it can be difficult to determine the required number of streams to achieve a certain performance given a FH capacity constraint. Furthermore, reduction of the signal dimension at the RU can impact DU ability to perform interference mitigation.

Aspects of the present disclosure address these and other concerns by predicting a MIMO layer-to-stream ratio and achieve adaptation of the requested number of streams based on the number of scheduled MIMO layers with a FH capacity constraint. Aspects of the present disclosure can also predict long-term inter-cell interference and achieve sounding reference signal (SRS)-based beamforming weight determination that is interference aware for 7.2× based port reduction.

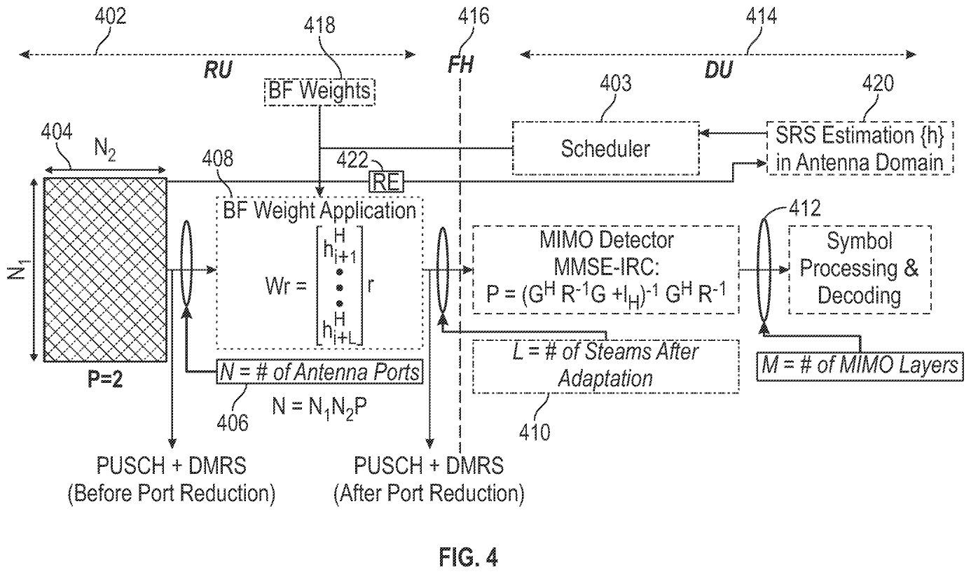

FIG. 4 illustrates a method for fronthaul stream adaptation in accordance with some aspects of the disclosure. The RU side 402 can receive signals from the air interface from one or multiple UEs over antennas 404, where dimensions N can be on the order of 32, 64, or 128, making the system a massive MIMO system with number of antenna ports 406 being N1*N2*P.

The RU 402 can convert this signal from the time to the frequency domain and applies beamforming weights at block 408 to compress the signal to reduce the traffic (e.g., the fronthaul capacity) into streams L (seen at block 410). These streams convey the information for M MIMO layers 412 to the DU side 414 through the open fronthaul interface 416 (and the DU side 414 can receive such indications through communication circuitry, e.g., a component of system 700). Beamforming information can be updated on a per slot basis. Therefore, the RU 402 can use updated beamforming weights for each new compression. These weights are adjusted by the scheduler 403 according to aspects of the disclosure discussed below, to provide stream adaptation based on FH capacity.

The scheduler 403 (at the DU 414) can apply an algorithm to determine a set of beamforming weights. The algorithm can be a function of the number of MIMO layers M (seen at 412). Compression cannot be into fewer streams L than the M number of MIMO layers. The maximum number of streams L also has an upper limit or ceiling, which is the maximum number of streams that can be conveyed through FH at any time.

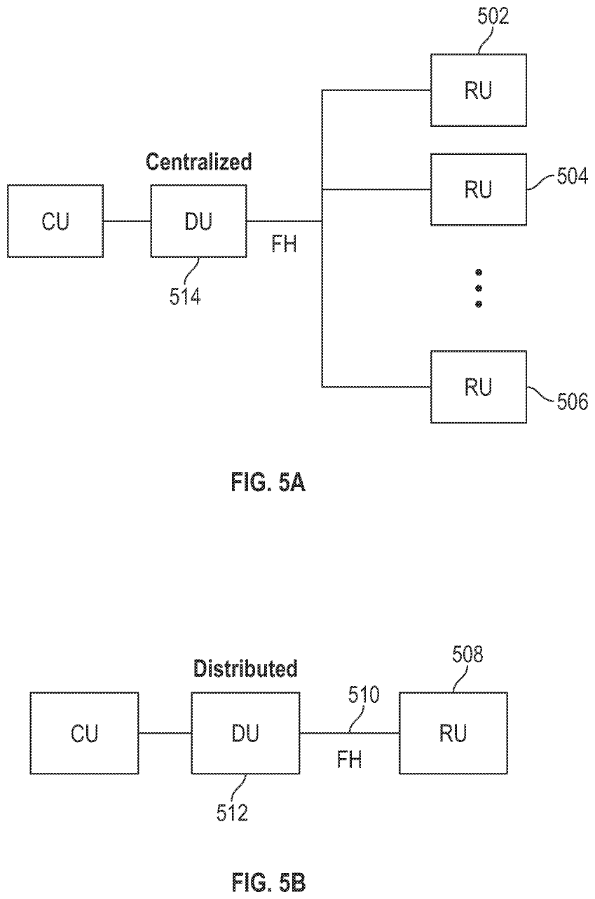

The scheduler 403 can schedule for one or multiple cells. FIG. 5A illustrates scheduling for multiple cells, for centralized or cloud RAN (C-RAN). FIG. 5B illustrates scheduling for a single cell 508 for distributed RAN (D-RAN). Each cell is characterized by its own RU 502, 504 506, 508. In FIG. 5B, the FH 510 is a point-to-point between one scheduler on the DU 512 to one RU 508. In this case, only one dimension (e.g., the frequency dimension) can be used for adaptation.

In contrast, in FIG. 5A, one centralized scheduler 514 can be provided for many RUs 502, 504, 506. While three RUs 502, 504, 506 are shown, any number of RUs could be connected, each serving one cell, the cells sharing one carrier or cells split into sectors each with a separate carrier for example. Any number of cells can be supported. In this case the frequency dimension is adaptable and additionally the number of RUs 502, 504, 506 can have varying numbers of streams assigned. Therefore, performance gains can be achieved through the different utilizations of the RUs 502, 504, 506. For example, if one RU is loaded more than another then the scheduler 403 algorithm can reallocate streams from the lightly-loaded RU to the heavily loaded RU-exploiting some statistical multiplexing gains. to keep the average stream number lower through RU stream allocation.

The scheduling algorithm applied at scheduler 403 is designed to adapt the number of FH streams (uplink) as a function of the number of PUSCH layers to meet PUSCH performance and FH capacity constraints. In cases of D-RAN (e.g., FIG. 5A), FH capacity is limited the number of fiber ports in the design whereas for C-RAN (e.g., FIG. 5B) connection between RUs 502, 504, 506 and DU 514 could have a capacity bound that is lower than the capacity implied by the number of fiber ports in RU or/and DU. This can be due to sharing of network resources in the wider network (with switches, shared fiber, etc.) between RUs 502, 504, 506 and DU 514. Therefore at least the two scenarios shown in FIG. 5A and FIG. 5B should be considered in the scheduler 403 algorithm, with further consideration as to frequency reuse, carriers per sector, and other considerations.

The scheduling algorithm applied at scheduler 403 can map or calculate a layer-to-stream ratio for 7.2× using a piecewise linear function (although aspects are not limited thereto) that exploits statistical multiplexing gains. Other algorithm choices are possible for example considering impact of multilevel coded spreading symbols (MCS) or consideration of past block error rate (BLER) performance, or data-driven algorithms such as machine learning (ML). Fronthaul networks, especially serving large number of RUs can be sized significantly smaller using algorithms according to aspects of this disclosure.

Referring again to FIG. 4, the scheduling algorithm can proceed as described below, considering a piecewise linear relationship between number of layers M and number of steams L. Two parameters are defined to reflect the upper constraint of FH 416 capacity. S2 can be defined as a target maximum number of streams, and S3 is a target average number of streams.

For the scenario depicted in FIG. 5B, where one FH 416 services one RU (and, e.g., this RU serves one cell), mapping the number of layers to actual number of streams can be understood as being done on a transmission timing interval (TTI) basis, where the actual number of streams can vary per scheduling unit (e.g., 4 PRB). In this scenario, a single unknown A is used to map the number of layers M to the actual number of streams. Then, in each TTI, solve A, such that

$$mean ( L ( k ) = min ( ceil ( M ( k ) * A ) , S 2 ) ) <= S 3 ,$$

where L(k) is the actual number of streams for k-th scheduling unit, M(k) is the number of layers for k-th scheduling unit, and wherein a trivial condition satisfied where M(k)=0 implies L(k)=0.

In the scenario depicted in FIG. 5A, aspects of the disclosure pool the scheduling units for all cells (e.g., 21 cells), and a single value of A applies to all cells in a given TTI.

The scheduler 403 can communicate those beamforming weights to one or more RUs in operation 418 through the FH 416. The beamforming weights can be applied as before at block 408 at multiple RUs (for multiple scheduling operations such as in FIG. 5A) or at a single RU (as in FIG. 5B) and the adaptive number of streams applied at one or multiple RUs (depending on configuration).

Referring still to FIG. 4, other aspects of the disclosure make use of interference information such as can be provided in SRS information, which can include interference information in the antenna domain as shown in block 420. A resource element (RE) 422 can be extracted, based on a request from DU 414, after FFT in the RU 403. The RE 422 can be in the antenna domain, not port reduced and non-beamformed provided only for measurement purposes. At block 420, based on the received RE 422 interference covariance estimation is performed at the DU. The estimated interference is processed to extract long-term predictable information that is suitable for beamforming weight determination.

The scheduler 403 can then determine interference-aware beamforming weights using the interference covariance information. At block 418 the beamforming weights can be provided to the RU 402, which the RU 402 can apply to PUSCH and PUSCH-DMRS REs. Aspects of the disclosure therefore can use historical inter-cell interference information to adjust 7.2× beamforming weights to take advantage of long-term predictable components of the interference (while ignoring short-term non-predictable components).

Based on received Res, the DU 414 (or scheduler 403 therein) can estimate DMRS, subtract the DMRS, and measure interference across all the antenna ports. Interference covariance can be averaged across the system bandwidth and combined with historical interference covariance according to Equation (1):

$$R ( t ) = α R ( t ) + ( 1 - α ) R ( t - 1 ) \qquad ( 1 )$$

where R(t) is the estimated interference covariance at time t, and R(t−1) is the estimated interference covariance at a previous time instance, t−1.

In preparation of BF weights, the DU 414 (or scheduler 403 therein) can use the latest interference covariance matrix to determine BF weights. Assuming R_{HH} is the sum of the user channel covariance for all the paired users in a scheduling unit (set of PRBs), then different algorithms can be used to generate BF weights (BFW), for example, svd(R^{-1/2} R_{HH}R^{-1/2}), BFW from svd(R_{HH}), whitened by R^{-1/2}, or BFW from svd(R_{HH}+R).

In the case of very large antenna arrays, it is intuitive that interference is localized in a space that is lower in dimension than the full dimension space. Therefore, there ought to be some benefit in the DU 414 being aware of this information. This benefit can be quantified using simulations.

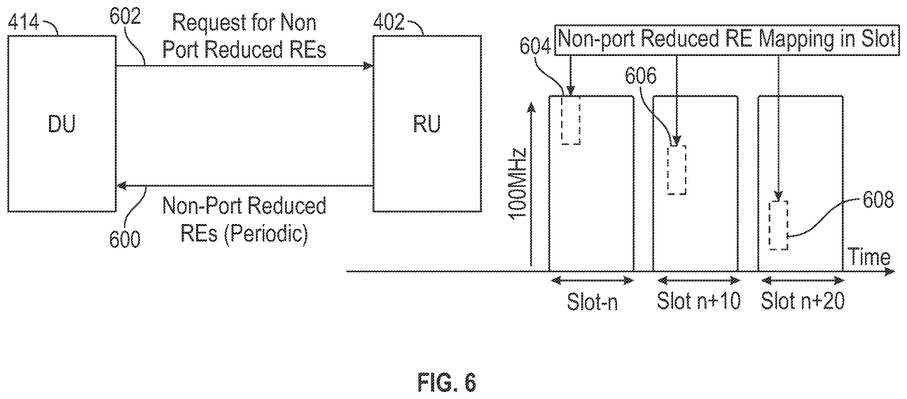

FIG. 6 illustrates sending a non-port reduced RE to a DU in accordance with some aspects of the disclosure. Non port reduced DMRS REs are transported from the RU 402 to the DU 414 periodically at signal 600. Alternatively non-allocated REs (non-port reduced) may be requested by the DU 414 at signal 602. These can be provided according to different mappings 604, 606, 608 in different time slots.

Aspects of the present disclosure can determine the required number of streams to achieve a certain performance given a fronthaul capacity constraint. Aspects further determine an interference aware beamforming methodology for 7.2× port reduction. Together, these and other aspects of the disclosure can improve the performance and reduce the complexity of O-RAN 7-2× compatible V-RAN implementation.

### Other Apparatuses and Description of Interfaces and Communications

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and further frequencies and Spectrum Access System (SAS) in 3.55-3.7 GHZ and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

Referring again to FIG. 1A, the UEs 101 and 102 may be configured to connect, e.g., communicatively couple, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112 or an unlicensed spectrum based secondary RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIG. 1B). In this aspect, the S1 interface 113 is split into two parts: the S1-U interface 114, which carries user traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and route data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN) and NG-eNB can be a secondary node (SN) in a 5G architecture. In some aspects, the master/primary node may operate in a licensed band and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server 160B, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

Referring again to FIG. 3, an E2 interface terminates at a plurality of E2 nodes. The E2 nodes are logical nodes/entities that terminate the E2 interface. For NR/5G access, the E2 nodes include the O-CU-CP 321, O-CU-UP 322, O-DU 315, or any combination of elements. For E-UTRA access the E2 nodes include the O-e/gNB 310. As shown in FIG. 3, the E2 interface also connects the O-e/gNB 310 to the Near-RT RIC 314. The protocols over the E2 interface are based exclusively on Control Plane (CP) protocols. The E2 functions are grouped into the following categories: (a) near-RT RIC 314 services (REPORT, INSERT, CONTROL, and POLICY, as described in O-RAN standards); and (b) near-RT RIC 314 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 3 shows the Uu interface between UE 301 and O-e/gNB 310 as well as between the UE 301 and O-RAN components. The Uu interface is a 3GPP-defined interface, which includes a complete protocol stack from L1 to L3 and terminates in the NG-RAN or E-UTRAN. The O-e/gNB 310 is an LTE eNB, a 5G gNB, or ng-eNB that supports the E2 interface. The O-e/gNB 310 may be the same or similar to other RAN nodes discussed previously. The UE 301 may correspond to UEs discussed previously and/or the like. There may be multiple UEs 301 and/or multiple O-e/gNB 310, each of which may be connected to one another via respective Uu interfaces. Although not shown in FIG. 3, the O-e/gNB 310 supports O-DU 315 and O-RU 316 functions with an Open Fronthaul interface between them.

The Open Fronthaul (OF) interface(s) is/are between O-DU 315 and O-RU 316 functions. The OF interface(s) includes the Control User

Synchronization (CUS) Plane and Management (M) Plane. FIG. 2 and FIG. 3 also show that the O-RU 316 terminates the OF M-Plane interface towards the O-DU 315 and optionally towards the SMO 302. The O-RU 316 terminates the OF CUS-Plane interface towards the O-DU 315 and the SMO 302.

The F1-c interface connects the O-CU-CP 321 with the O-DU 315. As defined by 3GPP, the F1-c interface is between the gNB-CU-CP and gNB-DU nodes. However, for purposes of O-RAN, the F1-c interface is adopted between the O-CU-CP 321 with the O-DU 315 functions while reusing the principles and protocol stack defined by 3GPP and the definition of interoperability profile specifications.

The F1-u interface connects the O-CU-UP 322 with the O-DU 315. As defined by 3GPP, the F1-u interface is between the gNB-CU-UP and gNB-DU nodes. However, for purposes of O-RAN, the F1-u interface is adopted between the O-CU-UP 322 with the O-DU 315 functions while reusing the principles and protocol stack defined by 3GPP and the definition of interoperability profile specifications.

The NG-c interface is defined by 3GPP as an interface between the gNB-CU-CP and the AMF in the 5GC. The NG-c is also referred to as the N2 interface (see [O06]). The NG-u interface is defined by 3GPP, as an interface between the gNB-CU-UP and the UPF in the 5GC. The NG-u interface is referred to as the N3 interface. In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC. In O-RAN, X2-c and X2-u protocol stacks defined by 3GPP are reused and may be adapted for O-RAN purposes.

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB. In O-RAN, Xn-c and Xn-u protocol stacks defined by 3GPP are reused and may be adapted for O-RAN purposes.

The E1 interface is defined by 3GPP as being an interface between the gNB-CU-CP (e.g., gNB-CU-CP 3728) and gNB-CU-UP (see e.g., [007], [O09]). In O-RAN, E1 protocol stacks defined by 3GPP are reused and adapted as an interface between the O-CU-CP 621 and the O-CU-UP 622 functions.

The O-RAN Non-Real Time (RT) RAN Intelligent Controller (RIC) 312 is a logical function within the SMO framework 202, 302 that enables non-real-time control and optimization of RAN elements and resources; AI/machine learning (ML) workflow(s) including model training, inferences, and updates; and policy-based guidance of applications/features in the Near-RT RIC 314.

In some embodiments, the non-RT RIC 312 is a function that sits within the SMO platform (or SMO framework) 302 in the O-RAN architecture. The primary goal of non-RT RIC is to support intelligent radio resource management for a non-real-time interval (i.e., greater than 500 ms), policy optimization in RAN, and insertion of AI/ML models to near-RT RIC and other RAN functions. The non-RT RIC terminates the A1 interface to the near-RT RIC. It will also collect OAM data over the O1 interface from the O-RAN nodes.

The O-RAN near-RT RIC 314 is a logical function that enables near-real-time control and optimization of RAN elements and resources via fine-grained data collection and actions over the E2 interface. The near-RT RIC 314 may include one or more AI/ML workflows including model training, inferences, and updates.

The non-RT RIC 312 can be an ML training host to host the training of one or more ML models. ML training can be performed offline using data collected from the RIC, O-DU 315, and O-RU 316. For supervised learning, non-RT RIC 312 is part of the SMO 302, and the ML training host and/or ML model host/actor can be part of the non-RT RIC 312 and/or the near-RT RIC 314. For unsupervised learning, the ML training host and ML model host/actor can be part of the non-RT RIC 312 and/or the near-RT RIC 314. For reinforcement learning, the ML training host and ML model host/actor may be co-located as part of the non-RT RIC 312 and/or the near-RT RIC 314. In some implementations, the non-RT RIC 312 may request or trigger ML model training in the training hosts regardless of where the model is deployed and executed. ML models may be trained and not currently deployed.

The A1 interface is between the non-RT RIC 312 (within or outside the SMO 302) and the near-RT RIC 314. The A1 interface supports three types of services, including a Policy Management Service, an Enrichment Information Service, and an ML Model Management Service.

In some embodiments, an O-RAN network node can include a disaggregated node with at least one O-RAN Radio Unit (O-RU), at least one O-DU coupled via an F1 interface to at least one O-CU coupled via an E2 interface to a RIC (e.g., RIC 312 and/or RIC 314).

As illustrated in FIG. 2 and FIG. 3, key interfaces in O-RAN (e.g., defined and maintained by O-RAN) include the following interfaces: A1, O1, O2, E2, Open Fronthaul M-Plane, and O-Cloud. O-RAN network functions (NFs) can be VNFs, VMs, Containers, and PNFs. Interfaces defined and maintained by 3GPP which are part of the O-RAN architecture include the following interfaces: E1, F1, NG-C, NG-U, X2, Xn, and Uu interfaces.

As illustrated in FIG. 2 and FIG. 3, the following O-RAN control loops may be configured:
(a) Loop-1: (O-DU Scheduler control loop) TTI msec level scheduling;
(b) Loop-2: (Near-RT RIC) 10-500 msec resource optimization; and
(c) Loop-3: (Non-RT RIC) Greater than 500 msec, Policies, Orchestration, and SON.

As illustrated in FIG. 2 and FIG. 3, the following O-RAN nodes may be configured:
(a) O-CU-CP: RRC and PDCP-C NFs (associated with Loop-2);
(b) O-CU-UP: SDAP and PDCP-UNFs (associated with Loop-2);
(c) O-DU: RLC, MAC, and PHY-U NFs (associated with Loop-1); and
(d) O-RU: PHY-L and RF (associated with Loop 1).

As illustrated in FIG. 2 and FIG. 3, the following O-RAN RIC components may be configured:
(a) Non-RT-RIC: Loop 3 RRM services (O1 and A1 interfaces); and
(b) Near-RT-RIC: Loop 2 RRM services (E2 interface).

As illustrated in FIG. 2 and FIG. 3, the following O-RAN interfaces may be configured:
(a) A1 interface is between Non-RT-RIC and the Near-RT RIC functions; A1 is associated with policy guidance for control-plane and user-plane functions; Impacted O-RAN elements associated with A1 include O-RAN nodes, UE groups, and UEs;
(b) O1 interface is between O-RAN Managed Element and the management entity; O1 is associated with Management-plane functions, Configuration, and threshold settings mostly OAM & FCAPS functionality to O-RAN network functions; Impacted O-RAN elements associated with O1 include mostly O-RAN nodes and UE groups (identified e.g. by S-NSSAI and slice ID), sometimes individual UEs (pending solution for UE identifiers);
(c) O2 interface is between the SMO and Infrastructure Management Framework; O2 is associated with the management of Cloud infrastructure and Cloud resources allocated to O-RAN, FCAPS for O-Cloud; Impacted O-RAN elements associated with O2 include O-Cloud, UE groups, and UEs;
(d) E2 interface is between Near-RT RIC and E2 node; E2 is associated with control-plane and user-plane control functions; Impacted O-RAN elements associated with E2 include mostly individual UEs, sometimes UE groups and E2 nodes;
(e) E2-cp is between Near-RT RIC and O-CU-CP functions. E2-up is between Near-RT RIC and O-CU-UP functions;
(f) E2-du is between Near-RT RIC and O-DU functions. E2-en is between Near-RT RIC and O-eNB functions; and
(g) Open Fronthaul Interface is between O-DU and O-RU functions; this interface is associated with CUS (Control User Synchronization) Plane and Management Plane functions and FCAPS to O-RU; Impacted O-RAN elements associated with the Open Fronthaul Interface include O-DU and O-RU functions.

As illustrated in FIGS. 1A-FIG. 3, the following 3GPP interfaces may be configured:
(a) E1 interface between the gNB-CU-CP and gNB-CU-UP logical nodes. In O-RAN, it is adopted between the O-CU-CP and the O-CU-UP.
(b) F1 interface between the gNB-CU and gNB-DU logical nodes. In O-RAN, it is adopted between the O-CU and the O-DU. F1-c is between O-CU-CP and O-DU functions. F1-u is between O-CU-UP and O-DU functions.
(c) The NG-U interface is between the gNB-CU-UP and the UPF in the 5GC and is also referred to as N3. In O-RAN, it is adopted between the O-CU-UP and the 5GC.
(d) The X2 interface connects eNBs or connects eNB and en-gNB in EN-DC. In O-RAN, it is adopted for the definition of interoperability profile specifications. X2-c is for the control plane. X2-u for a user plane.
(e) The Xn interface connects gNBs, and ng-eNBs, or connects ng-eNB and gNB. In O-RAN, it is adopted for the definition of interoperability profile specifications. Xn-c is for the control plane. Xn-u is for the user plane.
(f) The UE to e/gNB interface is the Uu interface and is a complete protocol stack from L1 to L3 and terminates in the NG-RAN. Since the Uu messages still flow from the UE to the intended e/gNB managed function, it is not shown in the O-RAN architecture as a separate interface to a specific managed function.

In example embodiments, any of the UEs or RAN network nodes discussed in connection with FIG. 1A-FIG. 6 can be configured to operate using the techniques discussed herein associated with multi-access traffic management in an O-RAN architecture.

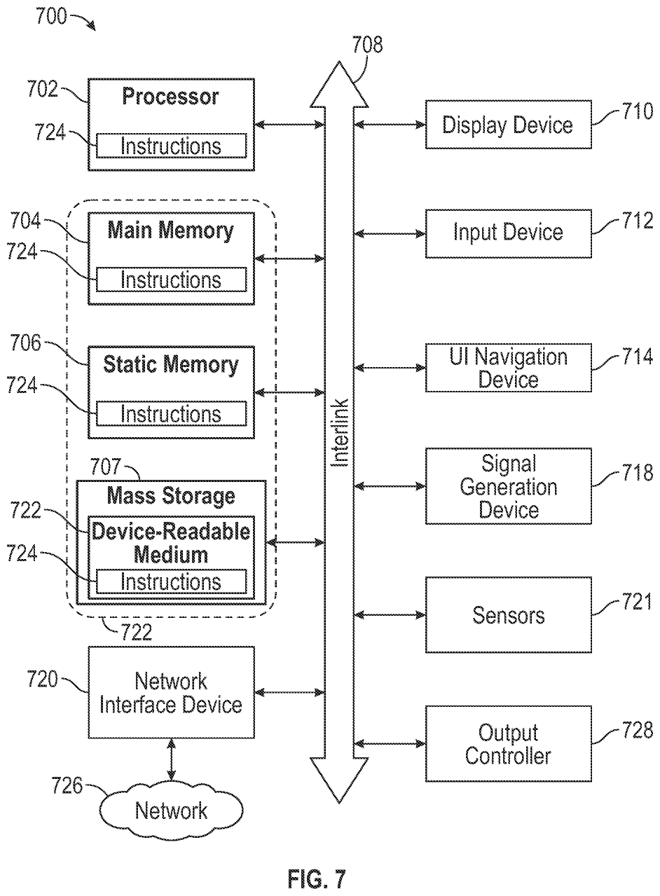

FIG. 7 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects and to perform one or more of the techniques disclosed herein. In alternative aspects, the communication device 700 may operate as a standalone device or may be connected (e.g., networked) to other communication devices.

The communication device may include a hardware processor 702 (e.g., a central processing unit (CPU), a graphics processing unit (GPU), a hardware processor core, or any combination thereof), a main memory 704, a static memory 706, and mass storage 707 (e.g., hard drive, tape drive, flash storage, or other block or storage devices), some or all of which may communicate with each other via an interlink (e.g., bus) 708.

The communication device 700 may further include a display device 710, an alphanumeric input device 712 (e.g., a keyboard), and a user interface (UI) navigation device 714 (e.g., a mouse). In an example, the display device 710, input device 712, and UI navigation device 714 may be a touchscreen display. The communication device 700 may additionally include a signal generation device 718 (e.g., a speaker), a network interface device 720, and one or more sensors 721, such as a global positioning system (GPS) sensor, compass, accelerometer, or another sensor. The communication device 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage 707 may include a communication device-readable medium 722, on which is stored one or more sets of data structures or instructions 724 (e.g., software) embodying or utilized by any one or more of the techniques or functions described herein. In some aspects, registers of the processor 702, the main memory 704, the static memory 706, and/or the mass storage 707 may be, or include (completely or at least partially), the device-readable medium 722, on which is stored the one or more sets of data structures or instructions 724, embodying or utilized by any one or more of the techniques or functions described herein. In an example, one or any combination of the hardware processor 702, the main memory 704, the static memory 706, or the mass storage 707 may constitute the device-readable medium 722.

As used herein, the term “device-readable medium” is interchangeable with “computer-readable medium” or “machine-readable medium.” While the communication device-readable medium 722 is illustrated as a single medium, the term “communication device-readable medium” may include a single medium or multiple media (e.g., a centralized or distributed database, and/or associated caches and servers) configured to store the one or more instructions 724. The term “communication device-readable medium” is inclusive of the terms “machine-readable medium” or “computer-readable medium”, and may include any medium that is capable of storing, encoding, or carrying instructions (e.g., instructions 724) for execution by the communication device 700 and that causes the communication device 700 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 724 may further be transmitted or received over a communications network 726 using a transmission medium via the network interface device 720 utilizing any one of several transfer protocols. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one single-input-multiple-output (SIMO), multiple-input multiple-output (MIMO), or multiple-input-single-output (MISO) techniques. In some examples, the network interface device 720 may wirelessly communicate using Multiple User MIMO techniques.

The term “transmission medium” shall be taken to include any intangible medium that is capable of storing, encoding, or carrying instructions for execution by the communication device 700, and includes digital or analog communications signals or another intangible medium to facilitate communication of such software. In this regard, a transmission medium in the context of this disclosure is a device-readable medium.

Example aspects of the present disclosure are further disclosed hereinbelow.

Example 1 is an apparatus comprising: communication circuitry configured to communicate with one or more radio units (RUs) over a fronthaul (FH) interface; a processor coupled to the communication circuitry and configured to: receive, over the communication interface, an indication of a number of multiple-input multiple-output (MIMO) layers to be scheduled, and information identifying the one or more RUs; assign a number of streams to the one or more RUs based on the number of MIMO layers; and provide the assigning to the number of RUs over the FH interface.

In Example 2, the subject matter of Example 1 can optionally include wherein the assigning is based on a FH capacity constraint.

In Example 3, the subject matter of any of Examples 1-2 can optionally include wherein the assigning is calculated using a piecewise linear function.

In Example 4, the subject matter of Example 3 can optionally include wherein the assigning is according to mean (L(k)=min(ceil(M(k)*A),S2))<=S3, where L(k) is an actual number of streams for k-th scheduling unit, M(k) is the number of layers for k-th scheduling unit.

In Example 5, the subject matter of any of Examples 1-4 can optionally include wherein the processor is configured to: request a non-port reduced resource unit (RE) from at least one RU; measure interference based on the RE; and generate beamforming weights based on the measured interference.

In Example 6, the subject matter of Example 5 can optionally include wherein the RE is received in a plurality of time slots in a different portion of a frequency band in at least two of the plurality of time slots.

In Example 7, the subject matter of Example 5 can optionally include wherein beamforming weights are calculate based on an interference covariance matrix.

Example 8 is an O-RAN device for performing any of Examples 1-7.

Example 9 is a non-transitory computer-readable medium including instructions that, when executed on a processor, cause the processor to perform operations comprising any elements of Examples 1-8.

Although example aspects have been described herein, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus comprising:
communication circuitry configured to communicate with one or more radio units (RUs) over a fronthaul (FH) interface;
a processor coupled to the communication circuitry and configured to:
receive, over the communication interface, an indication of a number of multiple-input multiple-output (MIMO) layers to be scheduled, and information identifying the one or more RUs;
assign a number of streams to the one or more RUs based on the number of MIMO layers; and
provide information regarding the assignment to the number of RUs over the FH interface.

2. The apparatus of claim 1, wherein the assigning is based on a FH capacity constraint.

3. The apparatus of claim 1, wherein the assigning is calculated using a piecewise linear function.

4. The apparatus of claim 3, wherein the assigning is according to mean (L(k)=min(ceil(M(k)*A),S2))<=S3,
where L(k) is an actual number of streams for k-th scheduling unit, M(k) is the number of layers for k-th scheduling unit.

5. The apparatus of claim 1, wherein the processor is configured to:
request a non-port reduced resource unit (RE) from at least one RU;
measure interference based on the RE; and
generate beamforming weights based on the measured interference.

6. The apparatus of claim 5, wherein the RE is received in a plurality of time slots in a different portion of a frequency band in at least two of the plurality of time slots.

7. The apparatus of claim 5, wherein beamforming weights are calculate based on an interference covariance matrix.

8. An Open Radio Access Network (O-RAN) device comprising:
communication circuitry configured to communicate with one or more radio units (RUs) over a fronthaul (FH) interface;
a processor coupled to the communication circuitry and configured to:
receive, over the communication interface, an indication of a number of multiple-input multiple-output (MIMO) layers to be scheduled, and information identifying the one or more RUs;
assign a number of streams to the one or more RUs based on the number of MIMO layers; and
provide the assigning to the number of RUs over the FH interface;
a memory coupled to the processor.

9. The device of claim 8, wherein the assigning is based on a FH capacity constraint.

10. The device of claim 8, wherein the assigning is calculated piecewise linear function.

11. The device of claim 10, wherein the assigning is according to mean (L(k)=min(ceil(M(k)*A),S2))<=S3,
where L(k) is an actual number of streams for k-th scheduling unit, M(k) is the number of layers for k-th scheduling unit.

12. The device of claim 8, wherein the processor is configured to:
request a non-port reduced resource unit (RE) from at least one RU;
measure interference based on the RE; and
generate beamforming weights based on the measured interference.

13. The device of claim 12, wherein the RE is received in a plurality of time slots in a different portion of a frequency band in at least two of the plurality of time slots.

14. The device of claim 12, wherein beamforming weights are calculate based on an interference covariance matrix.

15. A non-transitory computer-readable medium including instructions that, when executed on a processor, cause the processor to perform operations comprising:
receiving, over a fronthaul (FH) interface, an indication of a number of multiple-input multiple-output (MIMO) layers to be scheduled, and information identifying one or more radio units (RUs);
assigning a number of streams to the one or more RUs based on the number of MIMO layers; and
providing the assigning to the number of RUs over the FH interface;
a memory coupled to the processor.

16. The non-transitory computer-readable medium of claim 15, wherein the assigning is based on a FH capacity constraint.

17. The non-transitory computer-readable medium of claim 15, wherein the assigning is calculated using a piecewise linear function.

18. The non-transitory computer-readable medium of claim 17, wherein the assigning is according to mean (L(k)=min(ceil(M(k)*A),S2))<=S3, where L(k) is an actual number of streams for k-th scheduling unit, M(k) is the number of layers for k-th scheduling unit.

19. The non-transitory computer-readable medium of claim 15, wherein the processor is configured to:
request a non-port reduced resource unit (RE) from at least one RU;
measure interference based on the RE; and
generate beamforming weights based on the measured interference.

20. The non-transitory computer-readable medium of claim 19, wherein the RE is received in a plurality of time slots in a different portion of a frequency band in at least two of the plurality of time slots.
